(19) United States
(12) Patent Application Publication
(10) Pub. No.: US 2018/0011739 A1
(43) Pub. Date: Jan. 11, 2018

(54) DATA FACTORY PLATFORM AND OPERATING SYSTEM

(71) Applicant: Dragonfly Data Factory LLC, Holliston, MA (US)

(72) Inventors: Ranga Ram Pothula, Holliston, MA (US); Venkata Janapareddy, Westford, MA (US); David William Freund, Apex, NC (US); Harshada Ram Pothula, Holliston, MA (US); Kenneth Matthew Zimmerman, Boston, MA (US); Serhiy Blazhiyevskyy, San Jose, CA (US); Chandana Bhargava, Orlando, FL (US); Sumant Pal, Newton, MA (US)

(21) Appl. No.: 15/546,524

(22) PCT Filed: Jan. 26, 2016
(86) PCT No.: PCT/US16/14804

§ 371 Date: Jul. 26, 2017

Related U.S. Application Data
(60) Provisional application No. 62/107,910, filed on Jan. 26, 2015.

(51) Int. Cl. G06F 9/50; G06Q 10/06; G06F 17/30

(52) U.S. Cl. CPC G06F 9/50; G06F 17/3012; G06Q 10/0633

(57) ABSTRACT

Methods, systems, and apparatus, including computer programs encoded on a computer storage medium, for executing software on distributed computing systems. In one aspect, a method comprises executing a workflow controller configured to manage a plurality of factory workflows; executing a plurality of extraction workers, each configured to extract data from a plurality of external data sources into plurality of extracted datasets; executing a plurality of intermediate workers, each configured to integrate and/or contextualize the extracted data sets into a plurality of intermediate datasets; and executing a plurality of visualization workers, each configured to use the intermediate datasets to produce an interactive display or a plurality of reports based on the intermediate datasets.

### PRIORITY CLAIM

This application claims priority to U.S. Provisional Patent Application No. 62/107,910, entitled “ DATA FACTORY PLATFORM AND OPERATING SYSTEM,” filed Jan. 26, 2015, the entire contents of which are hereby incorporated by reference.

### TECHNICAL FIELD

This disclosure relates generally to systems of computers, e.g., systems of computers configured to develop software for processing large amounts of data on distributed computing systems.

### BACKGROUND

The term “Big Data” generally refers to collections of data sets that are large and complex enough that they are difficult to process using conventional data processing applications. Big Data can be collected in computer applications for various topical areas, e.g., meteorology, genomics, Internet search, business informatics, and environmental research. Apache Hadoop is an open-source software framework for distributed storage and distributed processing of Big Data on distributed computing systems, e.g., clusters of commodity hardware. Various other software packages can be installed on top of or alongside Hadoop, e.g., Apache Pig, Apache Hive, Apache HBase, and Apache Spark.

### SUMMARY

In general, one innovative aspect of the subject matter described in this specification can be implemented in methods that are performed by a distributed computing system comprising one or more networked computers configured to execute in parallel to perform at least one common task. In one aspect, a method comprises executing a workflow controller configured to manage a plurality of factory workflows; executing one or more extraction workers, each configured to extract data from a plurality of external data sources into one or more extracted datasets; executing one ore more intermediate workers, each configured to integrate and/or contextualize the extracted data sets into one or more intermediate datasets; and executing one or more visualization workers, each configured to use the intermediate datasets to produce an interactive display or one or more reports based on the intermediate datasets. Other embodiments of this aspect include corresponding systems, apparatus, and computer programs, configured to perform the actions of the methods, encoded on computer storage devices. A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

These and other implementations can each optionally include one or more of the following features. The method comprises executing a worker watchdog for each extraction worker, integration worker, and visualization worker, wherein each worker watchdog is configured to monitor and control a task performed by the worker of the worker watchdog and send a plurality of status reports for the worker of the worker watchdog. The method comprises executing a worker controller configured to control worker watchdogs' actions and to receive status reports from the worker watchdogs and send status reports to the workflow controller. The method comprises executing a dataset controller and a dataset watchdog for each of the extracted datasets and the intermediate datasets, wherein each dataset watchdog is configured to receive metadata change events for the dataset of the dataset watchdog. Each dataset watchdog is configured to forward the metadata change vents to the dataset controller, and the dataset controller is configured to store the metadata changes in a meta-database. The method comprises executing an infrastructure controller configured to provide an abstraction layer configured to provide a common infrastructure-management interface to the extraction worker, the integration worker, and the visualization worker. The method comprises executing a user interface module configured to receive user inputs defining a workflow that specifies one or more worker instances and one or more dependencies between the worker instances. The method comprises executing a Hadoop distribution. The worker controller is configured to maintain a worker cache comprising a list of worker instances currently executing on the distributed computing system. The worker controller is configured to check the worker cache before creating a new worker instance and, if an instance on the list matches the new worker instance, using the instance on the list instead of the new worker instance

The details of one or more disclosed implementations are set forth in the accompanying drawings and the description below. Other features, aspects, and advantages will become apparent from the description, the drawings and the claims.

### BRIEF DESCRIPTION OF THE DRAWINGS

FIG. 1 is a block diagram illustrating an example data factory platform and operating system.

FIG. 2 is a block diagram of an example data factory workflow.

FIG. 3A is a block diagram illustrating data extraction and ingestion within a data factory workflow.

FIG. 3B is a block diagram illustrating data integration and transformation within a data factory workflow.

FIG. 3C is a block diagram illustrating adding context within a data factory workflow.

FIG. 3D is a block diagram illustrating preparation for visualization within a data factory workflow.

FIG. 4 is a flow diagram of an example process for executing a data factory workflow.

### DETAILED DESCRIPTION

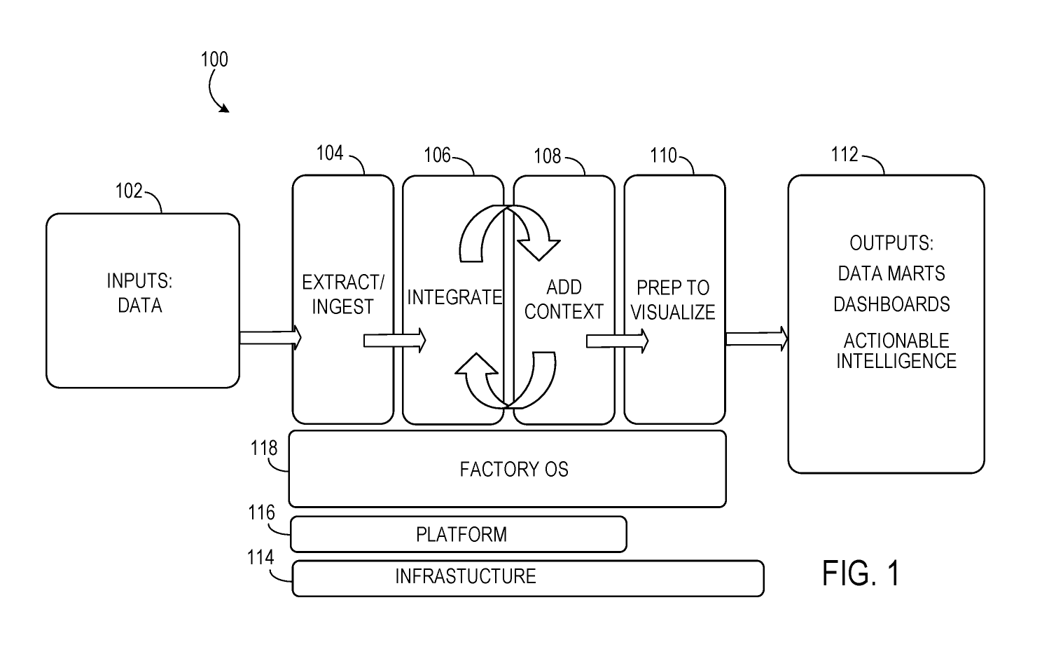

FIG. 1 is a block diagram illustrating an example data factory platform and operating system 100 in accordance with implementations of the present disclosure. The system 100 executes on an infrastructure 114 that includes a distributed computing system and software configured to execute tasks by distributing components across networked computing devices of the computing system.

The system 100 includes a platform 116 that includes software configured to provide tools and services to applications that can enable coding and deployment of the applications quick and efficient. The system also includes a factory operating system 118 that includes software configured to enable generation and deployment of applications for processing large amounts of data. Taken together, the infrastructure 114, platform 116, and factory operating system 118 can be a cloud computing stack for enabling network access to the distributed computing system for processing large amounts of data.

A data factory application (“data factory”) that executes on the factory operating system 118 can be represented as four software modules 104, 106, 108, and 110. An extraction/ingestion module 104 receives data 102 as an input and is configured to bring data from a variety of sources into the data factory. For example, the extraction/ingestion module 104 can be configured to translate data from a number of formats or data structures into formats and data structures that other modules of the data factory are configured to process. As another example, the extraction/ingestion module 104 can be configured to communicate with data sources outside the data factory, e.g., using a variety of data communication protocols.

An integration module 106 is configured to combine data from multiple sources, e.g., into a single, unified data source. For example, the integration module 106 can manipulate the data from multiple sources so that the data, in aggregate, is in a common data structure. In another example, the integration module 106 can manipulate the data from multiple sources to address semantic integration by ensuring consistent meaning of data items across disparate sources.

A context module 108 is configured to provide contextualization for the data 102. Data contextualization can be an aspect of data analysis that accounts for multiple sources of data to provide context for the data 102. For example, the context module 108 can use several aspects of each set of data, including the identity, demographic, behavioral profile, and reliability of the source of the data 102; the history and chain of data ownership and access; and other contextual clues such as time and location, and the activity prior, during, and after a specific data point.

The context module 108 can derive context at a macro level, e.g., a company's performance within its broader market segment. The context module 108 can derive context at a micro level, e.g., using the meaning of shorthand notations in a patient's medical chart (e.g., “HA” entered by a cardiologist typically means “heart attack,” while the same term entered by a nephrologist indicates “hyperactive bladder”). The context module 108 can use a combination of commercial-off-the-shelf (COTS) products and human insight and subject matter expertise to provide contextualization of the data 102. Sources of additional context can include previously integrated and transformed data or entirely new datasets, e.g., new real-time sources, newly received historical data, social data, or other data marts.

A visualization module 110 is configured to produce outputs 112 based on the integrated and contextualized data. For example, after the data has been integrated, analyzed, contextualized, and prepared (e.g., in a data mart), the visualization module 110 can produce an interactive display or one or more printed reports to visualize the data 102 in an intuitive way to facilitate human decision making.

In operation, the data factory can enable organizations to mine, manage, and monetize the growing volume, velocity, and variety of data. The data factory can virtualize multiple disparate Big Data and traditional data management and analytics software products into cloud-enabled services offered within a single, unified, software-defined data factory platform. The data factory can connect sensors, smart devices, and entire device clouds to the data factory. The data factory can provide context to data that, in some conventional systems, resides within discrete silos where it is difficult to access and apply effectively. The data factory can enable organizations to shift more information technology (IT) budgets from capital expenses to operational expenses.

The system 100 can provide orchestration, governing, monitoring, auditing, billing and other supporting connective services to comprise a comprehensive and cohesive service offering. The system 100 can use COTS products to provide services and can support arbitrary product combinations to serve specific client needs. The system 100 can operate on public, private, and hybrid cloud models.

In some implementations, the system 100 adheres to commonly accepted cloud-based computing principles, e.g., as set forth by the National Institute of Standards and Technology (NIST). The system 100 can provide on-demand self-service, pooled resources, broad network access, rapid elasticity, and metered service. The system 100 can be configured so that it is not dependent on any one third-party product or technology. The system 100 can be configured so that audit records survive the deletion of any (or all) objects to which they refer.

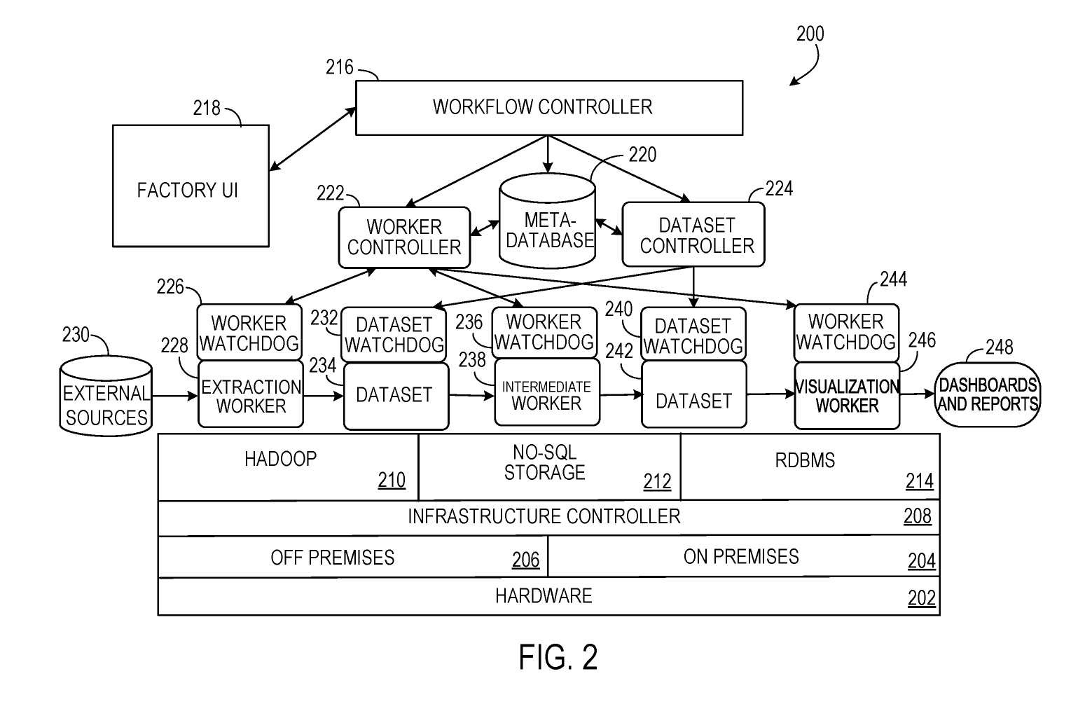

FIG. 2 is a block diagram of an example data factory workflow 200. A data factory workflow defines a sequence of actions across a data factory and can span multiple software products.

The workflow 200 executes on a distributed computing system that includes networked computing devices 202 that can be on premise 204 or off-premise 206. An infrastructure controller module 208 provides services for platform modules 210, 212, and 214 to access the distributed computing system. The infrastructure controller 208 can manage the provisioning of infrastructure resources, e.g., computers, networking, data storage. The platform modules can include a Hadoop distribution 210 (e.g., Cloudera, MapR, IBM BigInsights, Hortonworks), NoSQL storage software 212 (e.g., Mongo DB), and relational database storage software 214 (e.g., MySQL, Oracle).

The workflow 200 includes a workflow controller 216, a factory user interface (UI) 218 to access the workflow controller 216, and a meta-database 220. The workflow controller 216 is configured to manage the creation, deletion, modification, and execution of factory workflows. The factory UI 218 provides a user interface for end-users to define, modify, start, stop and schedule factory workflows.

The meta-database 220 is a combination of one or more data repositories and software that manages the repositories and communicates, e.g., using messages, with other factory components. The meta-database 220 can store metadata objects that represent objects and their attributes within a data factory, and the meta-database 220 can store an audit trail of significant events that occur within the data factory. The types of objects stored in the meta-database 220 can include objects in three categories: datasets, workers, and data factory operating system internal components and data. In some implementations, the meta-database does not store general-purpose data used by, e.g., third-party software products used within the data factory, or by additional third-party software products that may be used to manage data factory operations.

The workflow controller 216 can rely on worker controllers and dataset controllers, described further below, to define and manipulate specific datasets and workers. A “worker” is a software product used to accomplish a task within a data factory. A portfolio of workers can be made available to users of the data factory for use in designing and executing workflows that, e.g., extract, integrate, cleanse, transform, contextualize, and visualize data within the data factory. The example workflow 200 includes an extraction worker 228 that extracts data from external sources 230, an integration worker 238 that processes a first intermediate dataset 234, and a visualization worker 246 that processes a second intermediate dataset 242 to produce, e.g., dashboards and reports 248.

Each worker can have an associated Worker Control Block (WCB) stored in the meta-database 220 that describes the worker's attributes. The attributes can be, e.g., product name, version, capabilities (e.g., supported input/output dataset types, supported common functions), and supported watchdog version list. Each instance of a worker executing within the data factory can have an associated worker instance control block (WICB) that describes the instance's attributes. The attributes can be, e.g., the governing controller, the WCB describing the worker software executing within the instance, the workflow that started the worker instance, and whether or not the worker instance persists beyond the life of the workflow that started it (e.g., a continuous, real-time worker).

A dataset is a set of data contained within a data store, e.g., a NoSQL database, a relational database, a HIVE store, an HDFS flat file, and so on. A dataset can be an object created by a worker, which can be a third-party software product. Schema for a dataset, as available and appropriate, can be represented in metadata associated with the dataset. In some implementations, the data factory uses repositories, e.g., relational databases, that directly support schema, or incorporates data-serialization technologies to provide a schema description along with the data within the dataset. In some other implementations, storage of schema associated with a dataset is maintained in the meta-database 220.

Each dataset can have an associated dataset control block (DCB) stored in the meta-database 220 that describes the dataset's attributes. The attributes can be, e.g., a validity start timestamp, a validity end timestamp, a creation date/time, a worker instance ID that created the dataset, last modified date/time, a worker instance ID that last modified the dataset, a repository type (e.g., Cassandra, HIVE, HDFS), logical location (within the repository), physical location (e.g., for disaster recovery or other purposes), usage intent (e.g., as a reference—a frequency accessed repository used by a worker to look up data as it executes a workflow task, as an intermediate—a repository used to share data between workers within a workflow, as a data warehouse, as a data mart), workflow persistence (whether or not the dataset should be preserved after the workflow that created it completes), growth rate (e.g., static—no or insignificant growth, steady—stable, substantially constant growth over time, volatile—rapid spikes of incoming data with periodic “quiet” intervals, or exponential), arrival type (e.g., real-time substantially constant, real-time burst, periodic batch, or one-time delivery), composite dataset (indicating that, e.g., this dataset is a group of multiple datasets that are treated as a single entity for certain purposes, e.g., auditing, integrity-checking, and/or data protection; list of member/child dataset IDs can be included), composite membership (indicating that, e.g., this dataset is a member of a composite dataset; composite dataset ID can be included), current size, current growth rate, and a link to a predecessor DCB.

Workflow steps can be marked as dependent upon the successful start or completion of another step within the same workflow. Workflow steps can also execute in parallel. An entire workflow can be dependent upon the successful start or completion of another workflow. More complex logic and work constructs can be implemented by worker “tasks” (processing sequences executed within a “worker” software product).

To create the example workflow 200, a user interacts with the factory UI 218, which presents an editing workspace. The user specifies a name for the new workflow (which can be unique within the scope of the user's organization), and any required access-controls. The user can also set up an execution schedule for the workflow, or leave it available to execute on-demand (e.g., started manually by a user). The user can also designate one or more other workflows that must start or complete before this workflow is allowed to start.

The workflow controller 216 sends the collected information, along with a user ID, to the meta-database 220, which stores the information in a Factory Workflow Control Block (FWCB). The user then begins to create individual steps to execute within the workflow. For each step, the user can designate one or more other workflow steps that must start or complete before this step is allowed to start; in other words, a “dependency” on other steps. The system can use a default dependency that is the previous step in the workflow. Multiple steps in the workflow can be started in parallel when, for example, they all depend on the same other workflow step to complete. The user can also specify whether this step can be safely restarted (and how many times) if it fails during execution, and whether the workflow should stop if this step cannot be completed successfully.

As the user defines the steps, the workflow controller 216 sends this information (along with, e.g., the owner FWCB, the creating User ID, date/time) to the meta-database 220 to store within a workflow Step Control Block (SCB). When the user completes the workflow design, the resulting FWCB and associated SCBs are stored in the meta-database 220.

Workflow step order and dependencies are represented using a multi-linked list structure. The FWCB contains a variable-length list of pointers, or links, to the SCBs representing the first step(s) of the workflow called the “workflow-start list.” Each SCB contains a variable-length list of links to SCBs of steps that must successfully start before this step can execute (“start-dependency list”), a variable-length list of links to SCBs of steps that must complete before this step executes(“completion-dependency list”), a variable-length list of links to SCBs of steps to execute after this step starts successfully (“successful-start list”), and a variable-length list of links to SCBs of steps to start after this step completes successfully (“successful-completion list”). To start a workflow, the workflow controller 216 starts the step(s) linked by the FWCB workflow-start list.

Upon successful start of a step, the workflow controller 216 examines the SCB's successful-start list and evaluates each listed SCB to determine whether to start it. Similarly, upon successful completion of a step, the workflow controller 216 examines the SCB's successful-completion list and evaluates each listed SCB to determine whether to start it.

To evaluate an SCB for potential starting, the workflow controller 216 first checks whether the step represented by the SCB has already started. If so, evaluation of this SCB stops. Otherwise, the workflow controller 216 examines the SCB's start-dependency and completion-dependency lists, and fetches the status of each listed SCB. If all SCBs in the start-dependency list have successfully started and all SCBs in the completion-dependency list have successfully completed, then the step represented by the SCB being evaluated can be started. Otherwise, evaluation of this SCB stops; it will be evaluated again upon the next start or completion event for a step SCB upon which this step SCB is waiting.

As the workflow 200 executes, the workflow controller 216 monitors the status of the steps in the workflow 200 (e.g., using worker controllers and worker watchdogs, described further below) and will, as appropriate, restart steps. For example, if a worker instance crashes, the workflow controller 216 can instruct a worker controller for the crashed worker instance to launch a new worker instance and perform the step within the new instance instead of the original. This can help ensure reliable execution of the workflow 200 despite transient problems such as network or server failures.

As steps are executed, the workflow controller 216 can also store historical information about the job execution in the meta-database 220. The information about job execution can be preserved indefinitely and the user may choose to use it in the visualization of the job execution and analysis. When a workflow completes, the workflow controller 216 can log the event using the meta-database 220 along with its status (e.g., success, failure, abort), and it can start any workflows that are waiting for this workflow 200 to complete.

“Controllers” are software modules configured to initiate activities within a data factory. For workers and datasets, “watchdogs” are software modules configured to assist the controllers by monitoring the initiated activities and reporting status and/or significant events. The example workflow 200 includes a worker controller 222 and a dataset controller 224. The workflow 200 includes worker watchdogs 226, 236, and 244 for the extraction worker 228, the integration worker 238, and the visualization worker 246. The workflow 200 includes dataset watchdogs 232, 242 for the first and second intermediate datasets 234, 242.

Worker watchdogs can serve as the primary integration point for third-party software products used in the data factory as workers, e.g., by translating functional commands and status between controllers and corresponding workers. For example, a controller request to start a task within a worker can be sent to the corresponding worker watchdog, which translates that request into worker-specific Application Programming Interface (API) call sequences and parameters to make the worker start the requested task.

Watchdogs can be implemented on the same computing system as the object being watched, so in some implementations, watchdogs are configured to perform as little data factory operating system analysis and decision making tasks as possible in order to reduce any data factory operating system performance impact on that computing system. This can reduce the performance impact on the work being performed on behalf of the user.

The dataset controller 224 can be configured to manage dataset characteristics and significant events. The dataset watchdogs 232, 240 can be configured to connect to APIs associated with a specific, supported dataset repository type. The dataset watchdogs 232, 240 can monitor assigned datasets and characteristics of those dataset for significant events (e.g., size change) and forward those events to an appropriate dataset controller.

The worker controller 222 can be configured manage and monitor worker operations. The worker watchdogs 226, 236, and 244 can be configured to provide an interface for the data factory operating system to the workers and provide an interface for the workers to the data factory operating system. The worker watchdogs 226, 236 and 244 can, as directed by a controller, start, stop and relay task-related commands to a worker using a software API for the worker. The worker watchdogs 226, 236 and 244 can monitor the workers and the executing tasks for significant events (e.g., start, stop, status) and forward those events to an appropriate worker controller.

Processing in the workflow 200 can be done using batch processing or real-time processing. Workers within the workflow 200 can exhibit different types of persistence, depending on the processing application. Workers for batch processing tasks generally do not persist after the task is completed, but in some implementations, there is an exception of an adjustable, limited duration “time to live.” Workers for real-time processing tasks tend to operate continuously and therefore persist beyond the life of a workflow. Those workers can be decommissioned explicitly, e.g., by a workflow or manual act of a user.

Integrating batch and real-time processing can occur when a real-time worker accesses a batch-oriented dataset. For example, the worker can reference data that adds context to data contained in real-time stream(s) being processed. Integrating batch and real-time processing can also occur when a batch-oriented worker accesses real-time data. For example, a real-time worker can periodically write data into a batch-oriented dataset. In another example, a batch-oriented worker uses a remote procedure call (RPC) to access data in a running real-time worker. This dataset, which can be considered a “real time pseudo dataset,” can have a continuous Directed Acyclic Graph (DAG) topology that offers a distributed RPC interface to access data being tracked by the DAG, e.g., the current top five trending social media topics referring to “Data Factory.”

To manage multiple workflows within a data factory, the workflow controller 216 can use a “fair-share” approach to distribute resources among the executing workflows. For example, if one workflow is executing and another workflow starts, available workers will be allocated to the new workflow's workers until both workflows have an equal share of workers. The “fair-share” approach can be used with all or some other resources available and declared in the system, e.g., Hadoop task units, database connections, worker instances, infrastructure resources, and so on. A user can prioritize workflows by assigning priority weights to each workflow. For example, if a first workflow is assigned double the weight of a second workflow, the first workflow can be allocated twice the available resources as the second workflow.

In some implementations, the data factory executes on an Infrastructure as a Service (IaaS) cloud platform and can be independent of any specific IaaS provider. Different cloud providers can each have a unique programmable interface for performing provisioning and management operations on the provider's infrastructure. To be independent of a specific provider, the data factory uses an abstraction layer to provide a common infrastructure-management interface to other factory components. The abstraction can be implemented using the infrastructure controller 208. The infrastructure controller 208 can be configured to handle various common operations, e.g., provisioning systems (including processor cores, amount of random access memory (RAM), number and size of virtual disks, and so on) and networks, decommissioning systems and networks, storing and use of pre-installed system images, and so on.

The data factory can maintain different types of versioning. One type of versioning includes maintaining a history of objects as they enter, or are modified, and then removed from the data factory. Another type of versioning includes tracking the versions of software products used within the data factory. This type of versioning is useful, e.g., for ensuring that combinations of software products can be successfully used together within a factory and within specific workflows.

The data factory operating system can maintain histories of the creation, modification, and deletion of workers, datasets, and related metadata structures. To enable the histories, the data factory can record all changes to metadata in the meta-database 220. Metadata can be persisted indefinitely—including metadata for objects (e.g., datasets) that have been deleted from the data factory—which can enable auditing of the activities of the data factory. Older versions of metadata objects can be retrieved.

The software components of the data factory (e.g., workers, Hadoop distributions) can be represented by a metadata object in the meta-database 220. For example, a worker software product can be represented by a Worker Control Block (WCB). The associated controllers for each software component can maintain, for that software component, a list of other products with which it can operate. When a user designs a workflow, and before a workflow is started, the worker controller 216 can traverse the appropriate control-block structures to check whether there are any product-version incompatibilities. If there are incompatibilities, a warning can be presented to the user, who can decide whether or not to proceed, and in some cases, whether to ignore that specific warning in future executions of the workflow.

In some implementations, worker initialization can be a resource expensive operation, e.g., by using relatively large amounts of time. When a new workflow is submitting a new task to be executed by a worker, using a worker that has already been initialized and is already running is typically faster and more resource efficient than starting a new worker. To enable re-use of worker processes and virtual machines executing workers, the data factory can implement a worker cache.

The worker cache is a list of worker instances currently running in the data factory, and the worker controller 222 can maintain the worker cache. When a new task is to be started, the worker controller 222 checks the list and reuses a running worker instance when possible. If the worker for the new task is not in the cache, a new worker can be started. When a worker becomes idle, e.g., because its last task completes, the worker may not be shut down immediately. Instead, the worker controller 222 can start a timer—a “time-to-live” (TTL) countdown timer.

The duration of the TTL countdown timer can be a parameter that can be adjusted by a suitably privileged user. New tasks attempting to use that worker before the TTL countdown expires will re-use that worker instance (in some cases, up to a defined “task limit”). If the TTL expires before any new tasks have been assigned to the worker instance, the instance can be shut down. The worker cache can improve workflow performance, and can enable more efficient use of cloud IaaS resources, which can be useful, e.g., to save time and money for the data factory user.

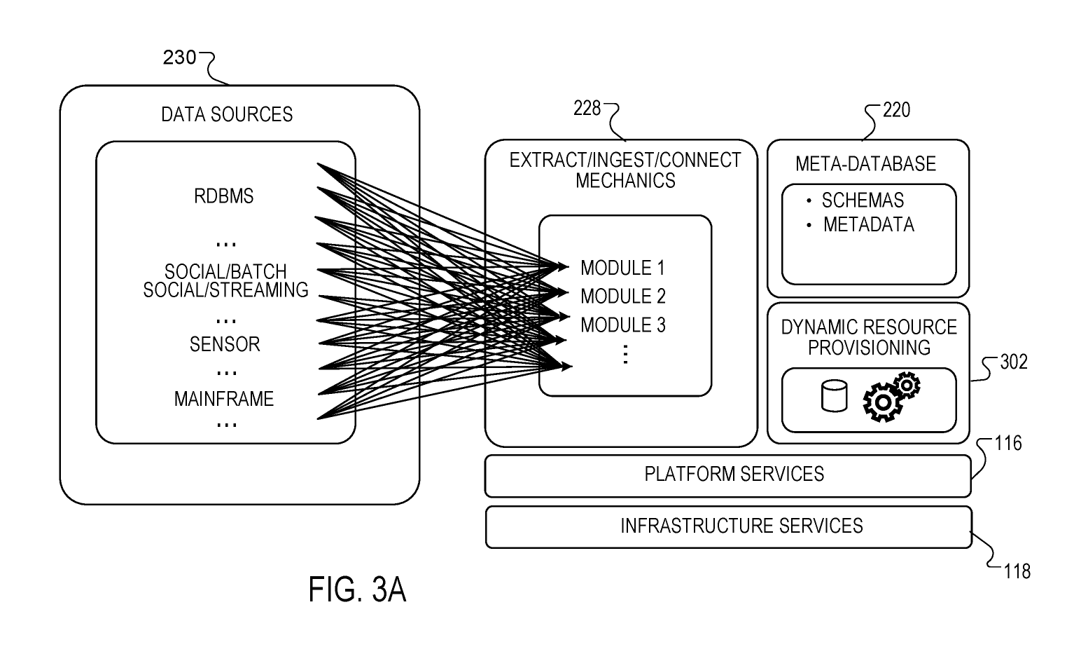

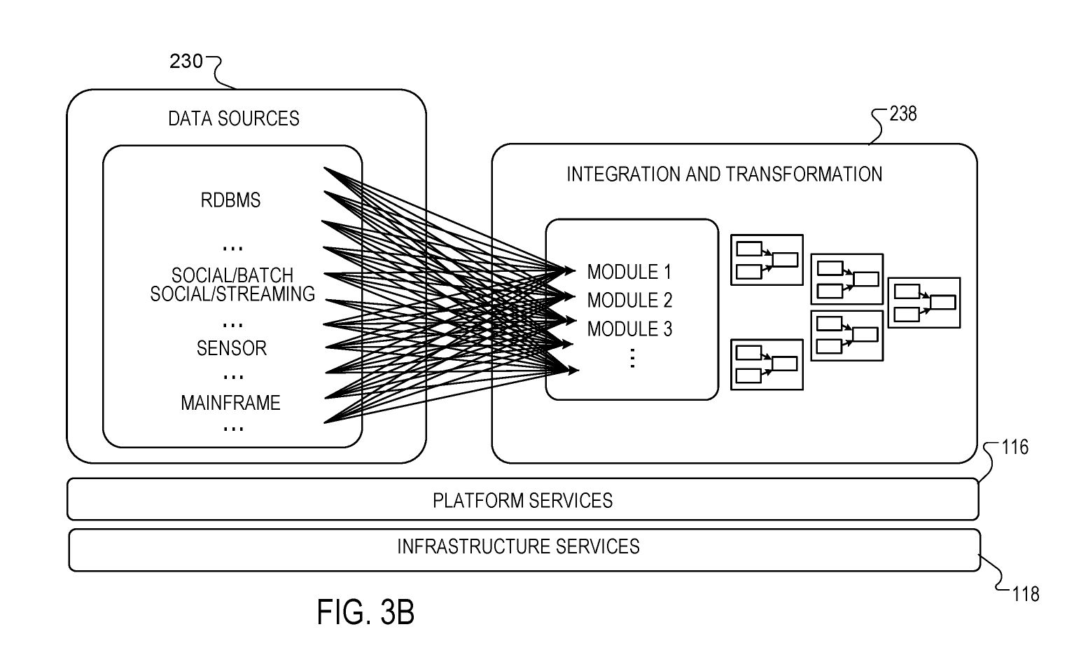

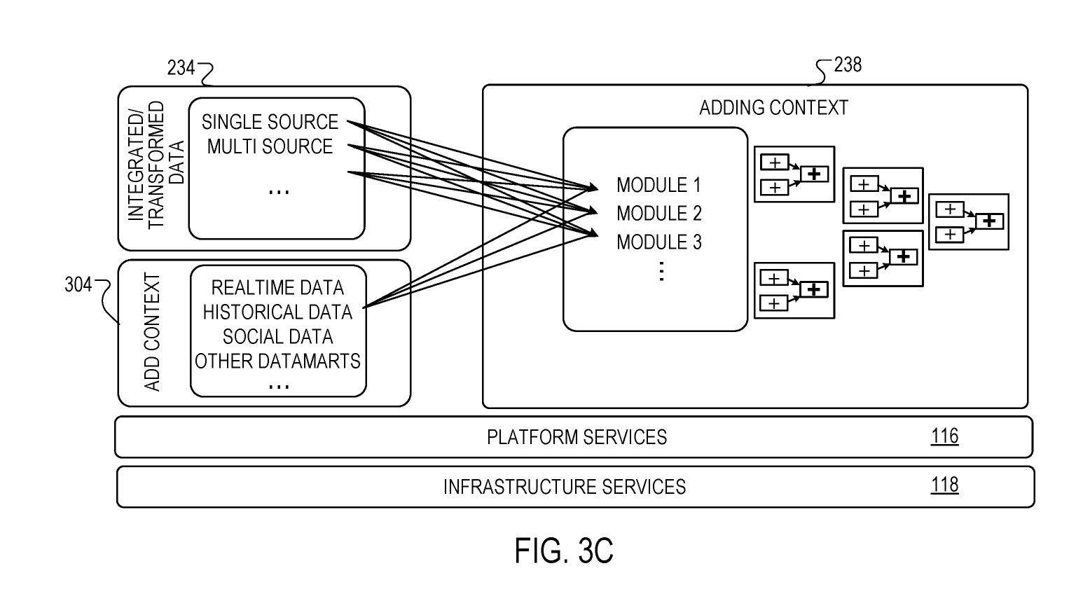

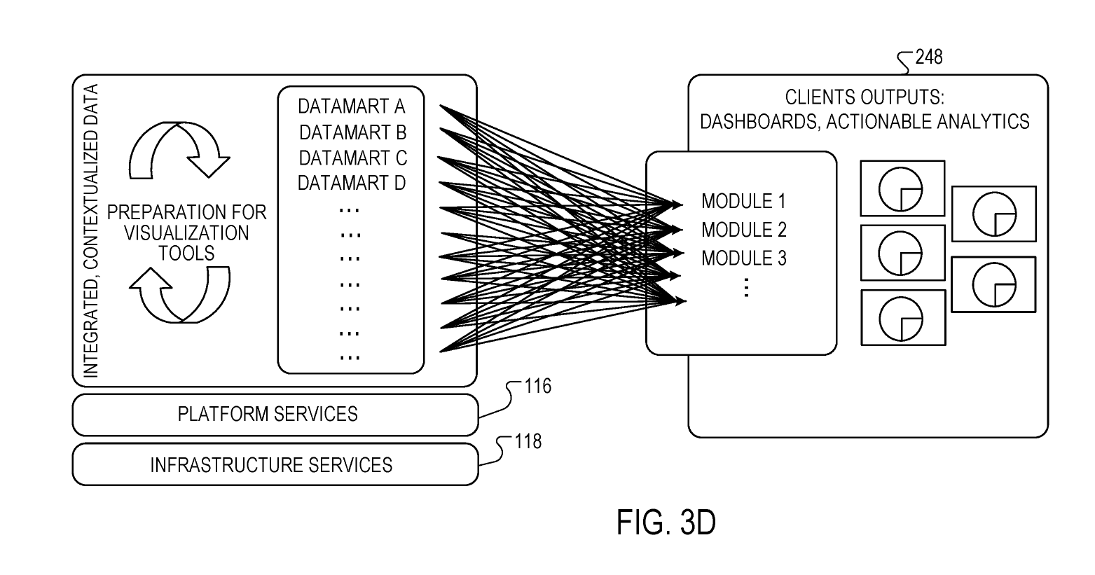

FIG. 3A is a block diagram illustrating data extraction and ingestion within a data factory workflow. The extraction worker 228 of FIG. 2 can perform tasks for data extraction and ingestion from external data sources 230.

Streaming data, including data from some types of sensors and device clouds, can be ingested into a data factory using continuously running clustered software that performs real-time analytics using the incoming data, stores the data in a factory dataset, or both. Data from other types of sources can enter the data factory by an extraction operation. For example, the extraction worker 228 can connect to external data sources 230, extract the data, optionally perform some other operations on the data, and write the results into the intermediate dataset 234.

Using the factory UI 218, a user can select an appropriate worker to use for an extraction step within a factory workflow. The user can then specify one or more target (output) datasets, including attributes for each, e.g., repository type (the specific product/technology container that will hold the data as Cassandra, HDFS file, and so on), the dataset's logical location, the dataset's name (which can be unique within the scope of the user's organization), and any access control list. The factory UI 218 sends the collected information, e.g., using a message, to the workflow controller 216. The workflow controller 216 can then send a message to the dataset controller 224. The dataset controller 224 starts a dataset watchdog instance for each target dataset. Each dataset watchdog attaches to the API hooks of the dataset's file system/repository and subscribes to file/repository metadata change vents related to the dataset, which can include its initial creation.

The workflow controller 216 can then send a message to the worker controller 222 requesting that it start the worker 228. The message also contains the target dataset(s) 234 to be written by the worker 228. The worker controller 222 starts an instance of a worker watchdog 226 designed to interface with that worker software product's API.

The worker watchdog 226 starts the worker 228 software; creates a template task (a named and executable sequence of operations within the worker 228 software) that includes the user specified target dataset(s), and any basic steps (and textual guidance for the user) to store the results of the task into the target dataset(s); inserts the task into the worker's internal task data structure; and attaches to the worker software's API hooks to subscribe to changes, execution start/stop/status, and any other event related to the inserted task.

The worker watchdog 226 can then coordinate with the worker controller 222 and workflow controller 216 to connect the extraction worker 228 software's UI to a graphical element within the factory UI 218. The precise mechanism used can vary based on the extraction worker 228 software UI capabilities (some can connect to any web browser, for example, while others will use remote virtual desktop technology). The user can then specify one or more external sources 230 for extraction. The user can also specify additional operations to be performed within the task.

Using the extraction worker 228 UI embedded within the factory UI 218, the user saves changes to the task. The worker watchdog 226 is notified of the Task change event, collects the full content of the task using the worker software API, and sends a message to the worker controller 222 notifying it of the task change event along with the task payload. The worker controller 222 sends the change notification, task payload and worker-internal unique identifier (Worker Task ID, or WTID) for the task to the workflow controller 216, which can then send this information to the meta-database 220 for logging the event and storing task the payload in the associated Workflow Step Control Block (SCB). The user can then exit the extraction worker 228 UI embedded within the factory UI 218.

The system can perform extraction when the workflow containing this step is executed, or when manually started during workflow design in the factory UI 218. The workflow controller 216 notifies the worker controller 222 to have the specific worker execute the designated worker task (specified by WTID). The worker controller 222 starts the appropriate worker watchdog 226, which in turn can start the worker 228 software if it's not already running. The worker watchdog 226 starts the specified task using the worker software API. Upon successful start of the task, the worker watchdog 226 notifies the worker controller 222 of the event. The worker controller 222 associates the task start event with the target datasets, and logs the event using the meta-database 220. The worker controller 222 notifies the workflow controller 216 of the successful task start. If this extraction was started manually by the user, the workflow controller 216 returns a success status to the factory UI 218.

If the task fails to start, the worker watchdog 226 collects appropriate diagnostic information using the worker 228 software API, and a failure event message is sent to the worker controller 222. The worker controller 222 logs the event and related details using the meta-database 220. The worker controller 222 forwards task-start failure information to the workflow controller 216 for error handling. If extraction was started manually by the user, the workflow controller 216 returns the error information to the factory UI 218.

As the worker 228 executes the task, it creates and/or writes data to the target dataset(s) 234. The dataset watchdog 232 associated with each target dataset 234 receives file/repository metadata change events, and forwards them to the dataset controller 224. The dataset controller 224 updates the associated DCB(s) and logs the event(s) in the meta-database 220.

If the task is marked “persistent” in the SCB (for example, starting a continuous, real-time process), there is no “completion” event to record, and no further action for the worker watchdog 226 and worker controller 222 to take for this workflow step. The workflow controller 216, upon receiving notification of a successful start of a persistent workflow step will move on to the next step in the workflow.

Any available/appropriate schema describing the data within the target dataset(s) 234 can be captured and retained in a manner facilitating easy access by other workers. In some implementations, the worker task uses repositories such as relational databases that directly support schema, or incorporates data-serialization technologies to provide a schema description along with the data within the dataset. In some implementations, storage of schema associated with a dataset is maintained in the meta-database 220, in which case the worker watchdog 226 obtains and communicates such schema information to its worker as appropriate.

When the task completes, the worker watchdog 226 receives the task completion event and its completion status using the worker 228 software API, and forwards it to the worker controller 222. The worker controller 222 associates the task completion event with the target datasets 234, and logs the event using the meta-database 220. The worker controller 222 notifies the workflow controller 216 of successful task completion. If the extraction is being executed manually by the user, the workflow controller 216 returns a success status to the factory UI 218.

If the task completes with an error, the worker watchdog 226 collects appropriate diagnostic information using the worker software API, and a failure event message is sent to the worker controller 222. The worker controller 222 logs the event and related details using the meta-database 220. The worker controller 222 forwards task-completion error information to the workflow controller 216 for error handling. If the extraction is being executed manually by the user, the workflow controller 216 returns the error information to the factory UI 218.

FIG. 3B is a block diagram illustrating data integration and transformation within a data factory workflow. The integration worker 238 of FIG. 2 can perform tasks for data integration and transformation.

After data has been placed within datasets inside the data factory by one or more extraction workers 228, additional steps in a factory workflow can be defined by the user to integrate data from multiple sources, analyze it, provide context for it, and prepare it for use by visualization worker 246 software.

Using the factory UI 218, a user selects an appropriate worker 238 to use for this step. The user can specify one or more source (input) datasets 234; and one or more target (output) datasets 242, including attributes for each such as repository type, the dataset's logical location, its name (which can be unique within the scope of the user's organization), and any access-control list. The factory UI 218 sends this information using a message to the workflow controller 216. The workflow controller 216 can then send a message to the dataset controller 224. The dataset controller 224 can then start a dataset watchdog 240 instance for each target dataset 242. Each dataset watchdog 240 attaches to the API hooks of the dataset's file-system/repository and subscribes to file/repository metadata change events related to the Dataset (including its initial creation).

The workflow controller 216 can then send a message to the worker controller 222 requesting that it start the worker 238. The message also contains the source dataset(s) 234 and target dataset(s) 242 to be read and written by the worker 238. The worker controller 222 starts an instance of a worker watchdog 236 designed to interface with that worker software product's API.

The worker watchdog 236 starts the worker 238 software; creates a template task (a named and executable sequence of operations within the worker 238 software) that includes the user specified source dataset(s), target dataset(s), and any basic steps (and textual guidance for the user) to store the results of the task into the target dataset(s); inserts the task into the worker's internal task data structure; and attaches to the worker software's API hooks to subscribe to changes, execution start/stop/status, and any other event related to the inserted task.

The worker watchdog 236 can then coordinate with the worker controller 222 and workflow controller 216 to connect the worker 238 software's UI to a graphical element within the factory UI 218. The precise mechanism used can vary based on the worker 238 software UI capabilities (some can connect to any web browser, for example, while others will use remote virtual desktop technology). The user can then specify operations to be performed within the task. For some implementations of contextualization, the user can also specify one or more external sources to also be used by the task.

Using the worker 238 UI embedded within the factory UI 218, the user saves changes to the task. The worker watchdog 236 is notified of the Task change event, collects the full content of the task using the worker software API, and sends a message to the worker controller 222 notifying it of the task change event along with the task payload. The worker controller 222 sends the change notification, task payload and worker-internal unique identifier (Worker Task ID, or WTID) for the task to the workflow controller 216, which can then send this information to the meta-database 220 for logging the event and storing task the payload in the associated Workflow Step Control Block (SCB). The user can then exit the extraction worker 228 UI embedded within the factory UI 218.

The system can perform this workflow step when the workflow containing it is executed, or when manually started during workflow design in the factory UI 218. The workflow controller 216 notifies the worker controller 222 to have the specific worker execute the designated worker task (specified by WTID). The worker controller 222 starts the appropriate worker watchdog 236, which in turn can start the worker 238 software if it's not already running. The worker watchdog 236 starts the specified task using the worker software API. Upon successful start of the task, the worker watchdog 236 notifies the worker controller 222 of the event. The worker controller 222 associates the task start event with the target datasets, and logs the event using the meta-database 220. The worker controller 222 notifies the workflow controller 216 of the successful task start. If this task was started manually by the user, the workflow controller 216 returns a success status to the factory UI 218.

If the task fails to start, the worker watchdog 236 collects appropriate diagnostic information using the worker 238 software API, and a failure event message is sent to the worker controller 222. The worker controller 222 logs the event and related details using the meta-database 220. The worker controller 222 forwards task-start failure information to the workflow controller 216 for error handling. If this step was started manually by the user, the workflow controller 216 returns the error information to the factory UI 218.

As the worker 238 executes the task, it creates and/or writes data to the target dataset(s) 242. The dataset watchdog 240 associated with each target dataset 242 receives file/repository metadata change events, and forwards them to the dataset controller 224. The dataset controller 224 updates the associated DCB(s) and logs the event(s) in the meta-database 220.

If the task is marked “persistent” in the SCB (for example, starting a continuous, real-time process), there is no “completion” event to record, and no further action for the worker watchdog 236 and worker controller 222 to take for this workflow step. The workflow controller 216, upon receiving notification of a successful start of a persistent workflow step will move on to the next step in the workflow.

Any available/appropriate schema describing the data within the target dataset(s) 242 can be captured and retained in a manner facilitating easy access by other workers. In some implementations, the worker task uses repositories such as relational databases that directly support schema, or incorporates data-serialization technologies to provide a schema description along with the data within the dataset. In some implementations, storage of schema associated with a dataset is maintained in the meta-database 220, in which case the worker watchdog 226 obtains and communicates such schema information to its worker as appropriate.

When the task completes, the worker watchdog 236 receives the task completion event and its completion status using the worker 238 software API, and forwards it to the worker controller 222. The worker controller 222 associates the task completion event with the target datasets 242, and logs the event using the meta-database 220. The worker controller 222 notifies the workflow controller 216 of successful task completion. If the step is being executed manually by the user, the workflow controller 216 returns a success status to the factory UI 218.

If the task completes with an error, the worker watchdog 236 collects appropriate diagnostic information using the worker software API, and a failure event message is sent to the worker controller 222. The worker controller 222 logs the event and related details using the meta-database 220. The worker controller 222 forwards task-completion error information to the workflow controller 216 for error handling. If the step is being executed manually by the user, the workflow controller 216 returns the error information to the factory UI 218.

FIG. 3C is a block diagram illustrating adding context within a data factory workflow. The integration worker 238 of FIG. 2 or another worker can perform tasks for adding context to data of an intermediate dataset 234. The integration worker 238 can draw from external or internal sources of context 304 to process the data. For example, the integration worker 238 can use several aspects of each set of data, including the identity, demographic, behavioral profile, and reliability of the source of the data; the history and chain of data ownership and access; and other contextual clues such as time and location, and the activity prior, during, and after a specific data point.

The integration worker 238 can derive context at a macro level, e.g., a company's performance within its broader market segment. The integration worker 238 can derive context at a micro level, e.g., using the meaning of shorthand notations in a patient's medical chart (e.g., “HA” entered by a cardiologist typically means “heart attack,” while the same term entered by a nephrologist indicates “hyperactive bladder”). The integration worker 238 can use a combination of custom-off-the-shelf (COTS) products and human insight and subject matter expertise to provide contextualization of the data. Sources of additional context can include previously integrated and transformed data or entirely new datasets, e.g., new real-time sources, newly received historical data, social data, or other data marts

FIG. 3D is a block diagram illustrating preparation for visualization within a data factory workflow. The visualization worker 246 of FIG. 2 can perform tasks for preparing for visualization of data in an intermediate dataset 242.

After data has been processed—e.g., integrated, analyzed, contextualized, and prepared (if needed) and persisted (in a Data Mart, for example)—a visualization step can be defined by a user to use a worker 246 software product that produces either an interactive display or one or more printed reports or other output to visualize the data and facilitate human decision-making.

Using the factory UI 218, the selects an appropriate visualization worker 246 to use for this step within a factory workflow. The user then specifies one or more source (input) datasets 242, and whether the intended use of this worker 246 is “Interactive” (which is recorded in the Workflow Step Control Block (SCB)). The factory UI 218 sends this information, e.g., using a message, to the workflow controller 216. The workflow controller 216 can then send a message to the worker controller 222, requesting that it start the worker 246. The worker controller 222 starts an instance of a worker watchdog 244 designed to interface with the worker 246 software product's API. The worker controller 222 also informs the working watchdog 244 whether or not this instance's intended use is “Interactive.”

The worker watchdog 244 starts the worker 246 software; creates a template task (a named and executable sequence of operations within the worker 246 software) that includes the user specified source dataset(s) 242. The worker watchdog 244 then inserts the task into the worker's internal task data structure; and attaches to the worker software's API hooks to subscribe to changes, execution start/stop/status, and any other event related to the inserted task.

The worker watchdog 244 then coordinates with the worker controller 222 and workflow controller 216 to connect the worker 246 software's UI to a graphical element within the factory UI 218. The precise mechanism used can vary based on the worker 246 software UI capabilities (some can connect to any web browser, for example, while others will use remote virtual desktop technology). The user can then specify operations to be performed within the task. The user can also use the worker 246 UI to specify one or more data sources external to the data factory for use in addition to previously specified datasets 242.

Using the worker 246 UI embedded within the factory UI 218, the user saves changes to the task. The worker watchdog 244 is notified of the task change event, collects the full content of the task using the worker software API, and sends a message to the worker controller 222 notifying it of the task change event along with the task payload. The worker controller 222 sends the change notification, task payload and worker-internal unique identifier (Worker Task ID, or WTID) for the task to the workflow controller 216, which can then send this information to the meta-database 220 for logging the event and storing task the payload in the associated Workflow Step Control Block (SCB). The user can then exit the visualization worker 246 UI embedded within the factory UI 218.

The system can perform this visualization step when the workflow containing it is executed, or when manually started by the user during workflow design in the factory UI 218. The workflow controller 216 notifies the worker controller 222 to have the specific worker 246 execute the designated worker task (specified by WTID). The worker controller 222 starts the appropriate worker watchdog 244, which in turn starts the worker 246 software, if it's not already running.

If the visualization workflow step has been designated as “Interactive,” the worker watchdog 244 connects the worker 246 software's UI to a graphical element within the factory UI 218 being used by the user, e.g., using the same mechanism used when designing this workflow step. Depending on a specific worker 246 software-product's design, attaching the worker UI may need to be performed after starting the task.

The worker watchdog 244 starts the specified task using the worker 246 software API. Upon successful start of the task, the worker watchdog 244 notifies the worker controller 222 of the event. The worker controller 222 logs the event using the meta-database 220. The worker controller 222 notifies the workflow controller 216 of the successful task start. If this task was started manually by the user, the workflow controller 216 returns a success status to the factory UI 218.

If the task fails to start, the worker watchdog 244 collects appropriate diagnostic information using the worker 246 software API, and a failure event message is sent to the worker controller 222. The worker controller 222 logs the event and related details using the meta-database 220. The worker controller 222 forwards task-start failure information to the workflow controller 216 for error handling. If this step was started manually by the user, the workflow controller 216 returns the error information to the factory UI 218.

As the worker 246 executes the task, it displays data in some graphical form in its UI or generates one or more reports or other output. When the task completes, the worker watchdog 244 receives the task completion event and its completion status using the worker 246 software API, and forwards it to the worker controller 222. If this is an “Interactive” visualization step, the worker watchdog 244 disconnects the worker 246 UI from the factory UI 218. In some implementations, the system does not include watchdogs for tracking specific reports; successful report generation is tracked using task completion status.

The worker controller 222 logs the task completion event using the meta-database 220. The worker controller 222 notifies the workflow controller 216 of successful task completion. If the step is being executed manually by the user, the workflow controller 216 returns a success status to the factory UI 218.

If the task completes with an error, the worker watchdog 244 collects appropriate diagnostic information using the worker software API, and a failure event message is sent to the worker controller 222. The worker controller 222 logs the event and related details using the meta-database 220. The worker controller 222 forwards task-completion error information to the workflow controller 216 for error handling. If the step is being executed manually by the user, the workflow controller 216 returns the error information to the factory UI 218.

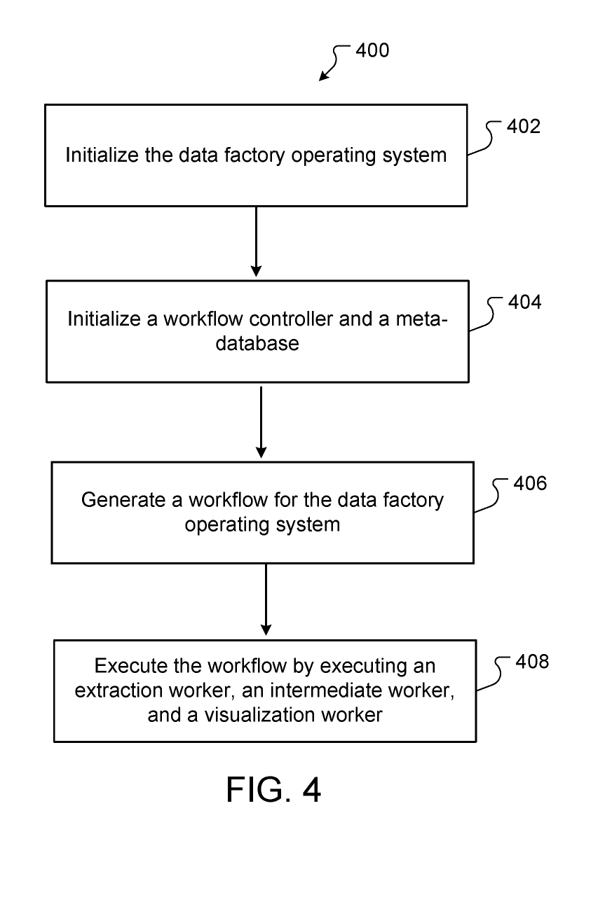

FIG. 4 is a flow diagram of an example process 400 for executing a data factory workflow. The process is performed by a distributed computing system, e.g., the system 100 of FIG. 1.

The system initializes the data factory operating system (402). Initializing the operating system can include initializing workflow controller and a meta-database for the data factory operating system (404). The workflow controller is configured to manage a plurality of factory workflows, and the meta-database is configured to store metadata for the data factory operating system, e.g., as described above with reference to FIG. 2. The system can execute an infrastructure controller configured to provide an abstraction layer configured to provide a common infrastructure-management interface to worker modules. After initializing the data factory operating system, the operating system can enter a wait state until a workflow is created and executed.

The system generates a workflow for the data factory operating system (406). For example, the system can present a factory user interface (UI) to a user, e.g., by presenting the factory UI in a web browser or other application on a user computing device. The user manipulates the factory UI to establish the components, e.g., controllers and watchdogs, and the flow structure of the workflow. In some implementations, the system authenticates the user to an account for the user's organization before presenting the factory UI to the user. The system can perform various other actions in generating the workflow and preparing to execute the workflow.

The system executes the workflow by executing a plurality of extraction workers, a plurality of intermediate workers, a plurality of visualization workers, and any other appropriate workers 408. Each extraction worker is configured to extract data from a plurality of external data sources into a plurality of extracted datasets. Each intermediate worker is configured to integrate and/or contextualize the extracted datasets into a plurality of intermediate datasets. Each visualization worker is configured to use the intermediate datasets to produce an interactive display or a plurality of reports based on the intermediate datasets. The system can also execute one or more worker controllers, worker watchdogs, dataset controllers, and dataset watchdogs.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims.

What is claimed is:

1. A system comprising:
a distributed computing system comprising one or more networked computers configured to execute in parallel to perform at least one common task; and
one or more computer readable storage mediums storing instructions that, when executed by the distributed computing system, cause the distributed computing system to execute software modules, including:
a workflow controller configured to manage a plurality of factory workflows;
a plurality of extraction workers, each configured to extract data from a plurality of external data sources into a plurality of extracted datasets;
a plurality of intermediate workers, each configured to integrate and/or contextualize the extracted data sets into a plurality of intermediate datasets; and
a plurality of visualization workers, each configured to use the intermediate datasets to produce an interactive display or a plurality of reports based on the intermediate datasets.

2. The system of claim 1, wherein the software modules include:
a worker watchdog for each of extraction worker, integration worker, and visualization worker, wherein each worker watchdog is configured to monitor a task performed by the worker of the worker watchdog and send a plurality of status reports for the worker of the worker watchdog.

3. The system of claim 2, wherein the software modules include a worker controller configured to control worker watchdogs' actions and to receive status reports from the worker watchdogs and send status reports to the workflow controller.

4. The system of claim 1, wherein the software modules include:
a dataset controller; and
a dataset watchdog for each of extracted dataset and intermediate dataset, wherein each dataset watchdog is configured to receive metadata change events for the dataset of the dataset watchdog.

5. The system of claim 4, wherein each dataset watchdog is configured to forward the metadata change vents to the dataset controller, and the dataset controller is configured to store the metadata changes in a meta-database.

6. The system of claim 1, wherein the software modules include an infrastructure controller configured to provide an abstraction layer configured to provide a common infrastructure-management interface to the extraction workers, the integration workers, and the visualization workers.

7. The system of claim 1, wherein the software modules include a user interface module configured to receive user inputs defining a workflow that specifies one or more worker instances and one or more dependencies between the worker instances.

8. The system of claim 1, wherein the software modules include a Hadoop distribution.

9. The system of claim 3, wherein the worker controller is configured to maintain a worker cache comprising a list of worker instances currently executing on the distributed computing system.

10. The system of claim 9, wherein the worker controller is configured to check the worker cache before creating a new worker instance and, if an instance on the list matches the new worker instance, using the instance on the list instead of the new worker instance.

11. A method performed by a distributed computing system comprising one or more networked computers configured to execute in parallel to perform at least one common task, the method comprising:
executing a workflow controller configured to manage a plurality of factory workflows;
executing an extraction worker configured to extract data from a plurality of external data sources into an extracted dataset;
executing an intermediate worker configured to integrate and/or contextualize the extracted data set into an intermediate dataset; and
executing a visualization worker configured to use the intermediate dataset to produce an interactive display or a report based on the intermediate dataset.

12. The method of claim 11, comprising executing a worker watchdog for each of the extraction worker, the integration worker, and the visualization worker, wherein each worker watchdog is configured to monitor a task performed by the worker of the worker watchdog and send a plurality of status reports for the worker of the worker watchdog.

13. The method of claim 12, comprising executing a worker controller configured to control worker watchdogs' actions and to receive status reports from the worker watchdogs and send status reports to the workflow controller.

14. The method of claim 11, comprising executing a dataset controller and a dataset watchdog for each of the extracted dataset and the intermediate dataset, wherein each dataset watchdog is configured to receive metadata change events for the dataset of the dataset watchdog.

15. The method of claim 14, wherein each dataset watchdog is configured to forward the metadata change vents to the dataset controller, and the dataset controller is configured to store the metadata changes in a meta-database.

16. The method of claim 11, comprising executing an infrastructure controller configured to provide an abstraction layer configured to provide a common infrastructure-management interface to the extraction worker, the integration worker, and the visualization worker.

17. The method of claim 11, comprising executing a user interface module configured to receive user inputs defining a workflow that specifies one or more worker instances and one or more dependencies between the worker instances.

18. The method of claim 11, comprising executing a Hadoop distribution.

19. The method of claim 13, wherein the worker controller is configured to maintain a worker cache comprising a list of worker instances currently executing on the distributed computing system.

20. The method of claim 19, wherein the worker controller is configured to check the worker cache before creating a new worker instance and, if an instance on the list matches the new worker instance, using the instance on the list instead of the new worker instance.
